(19) United States
(12) Patent Application Publication
(10) Pub. No.: US 2010/0194693 A1
(43) Pub. Date: Aug. 5, 2010

(54) ELECTRONIC APPARATUS, METHOD AND COMPUTER PROGRAM WITH ADAPTABLE USER INTERFACE ENVIRONMENT

(75) Inventors: Markus SELIN, Sundbyberg (SE); Donato PASQUARIELLO, Vasteras (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/362,875

(22) Filed: Jan. 30, 2009

(51) Int. Cl. G06F 3/041; G06F 3/033

(52) U.S. Cl. 345/173; 345/179

(57) ABSTRACT

An electronic apparatus comprising a user interface environment for operating the electronic apparatus wherein the user interface environment is arranged to present at least one graphical user interface item for user interaction is disclosed. The electronic apparatus further comprises an actuation position detector devised to detect user actuation; a stylus; a storage unit configured to store the stylus; a sensor unit configured to produce an output indicative of whether the stylus is stored in the storage unit and operatively coupled to the user interface environment, wherein the user interface environment is adapted based on the output from the sensor unit. Method and computer program for adapting a user interface environment are also disclosed.

### TECHNICAL FIELD

The present invention relates to an electronic apparatus, a method and a computer program. In particular, the invention relates to adaptation of a user interface environment depending on whether a stylus is stored in a storage unit.

### BACKGROUND

Many electronic apparatuses have graphical user interfaces. The ways of interacting with the graphical user interface can vary between apparatuses, and one way of interacting is through a touch sensitive unit, which determines a position where the touch sensitive unit is actuated. The actuation can be made by a stylus, i.e. a hand-holdable, elongated, pen-like object with a defined point, or by a body part such as a finger. However, there is a difference in abilities depending on what type of means that is used for the actuation. Therefore, there is a need for improvement of such user interfaces.

### SUMMARY

The present invention is based on the understanding that a user has different requirements on a user interface environment of an apparatus depending on whether the user intends to operate the apparatus by using a finger or by using a stylus. The inventors have found that a user would find it neat if the apparatus automatically adapts the user interface environment to the likely user intention. The inventors have solved this by introducing a sensor which determines whether the stylus is stored in a storage unit, wherein it is assumed that the user intends to operate the apparatus by a finger if the stylus is stored in the storage unit, and intends to operate the apparatus by the stylus if the stylus is out of the storage unit. Based on this assumption, the user interface environment is adapted to better suit the user's requirements.

According to a first aspect, there is provided an electronic apparatus comprising a user interface environment for operating the electronic apparatus wherein the user interface environment is arranged to present at least one graphical user interface item for user interaction. The electronic apparatus further comprises an actuation position detector devised to detect user actuation; a stylus; a storage unit configured to store the stylus; a sensor unit configured to produce an output indicative of whether the stylus is stored in the storage unit and operatively coupled to the user interface environment, wherein the user interface environment is adapted based on the output from the sensor unit.

The graphical user item may comprise at least one user selectable item, which upon selection is associated with execution of a command for operating the electronic apparatus. The dimension of the at least one graphical user interface item may be varied based on the output from the sensor unit. The number of selectable graphical user interface items may be varied based on the output from the sensor unit. The user interface environment may have at least two modes: a first mode, wherein the user interface environment is adapted for actuating the actuation position detector using a finger; and a second mode, wherein the user interface environment is adapted for actuating the actuation position detector using the stylus, wherein the user interface environment alternates between the two modes based on the output from the sensor unit. The user interface environment may be in the first mode when the output from the sensor unit indicates that the stylus is stored in the storage unit. The graphical user item may comprise at least one user selectable item, which upon selection is associated with execution of a command for operating the electronic apparatus, and wherein the at least one selectable graphical user interface item may be larger in first mode compared to the second mode. The selectable graphical user interface items may comprise any of a group comprising pictogram, grapheme, icon, virtual buttons, soft keys, menu selections, files, short-links, software program icons, letter icons and number icons. The electronic apparatus may further comprise a display unit configured to display the at least one graphical user interface item of the user interface environment; a display control unit operationally coupled to the sensor unit, and configured to provide image data to the display unit, wherein the image data provided by said display control unit comprises the at least one graphical user interface item and depends on the output from the sensor unit. The electronic apparatus may further comprising a user actuation detection control unit configured to control a least one parameter of the actuation position detector, wherein the at least one parameter may comprise any of a group comprising sensitivity, repeat rate and resolution, and wherein the user actuation detection control unit may adjust the at least one parameter based on the output from the sensor unit. The user actuation position detector may comprise a touch sensitive unit, which identifies a user selection upon physical contact between a finger or the stylus with the touch sensitive unit.

According to a second aspect, there is provided a method for adapting a user interface environment of an electronic apparatus. The method comprises determining whether a stylus is stored at a storage unit configured to store the stylus; and adapting the user interface environment based on whether the stylus is stored in the storage unit.

The adapting may comprise adapting at least one graphical user interface item of the user interface environment to whether the stylus is stored in the storage unit.

The method may further comprise alternating the user interface environment between a first mode, in which the user interface environment is adapted for operating the electronic apparatus using a finger, and a second mode, in which the user interface environment is adapted for operating the electronic apparatus using the stylus, depending on whether the stylus is stored in the storage unit; and determining the mode of the user interface environment to be in the first mode when the stylus is stored in the storage unit.

The method may further comprise presenting a selected set of graphical user interface items of the user interface environment such that the user interface items are available for actuation depending on whether the stylus is stored in the storage unit. The method may further comprise executing at least one predefined software program depending on whether the stylus is stored in the storage unit.

The method may further comprise adapting a theme of the user interface environment depending on whether the stylus is stored in the storage unit.

According to a third aspect, there is provided a computer readable medium comprising program code, which when executed by a processor comprised in an electronic apparatus, causes the processor to perform the method according to the second aspect.

The program code causes the processor to perform determination of whether a stylus is stored in a storage unit based on data from a sensor unit; and adjustment of a user interface environment based on whether the stylus is stored in the storage unit.

### BRIEF DESCRIPTION OF DRAWINGS

FIGS. 1 to 4 illustrate apparatuses according to embodiments with user interface environments adaptable to whether a stylus is stored in a storage unit.

FIGS. 5 and 6 are flow charts illustrating methods according to embodiments for adapting user interface environment.

FIG. 7 schematically illustrates a computer-readable medium for storing a computer program for adapting user interface environment.

### DETAILED DESCRIPTION

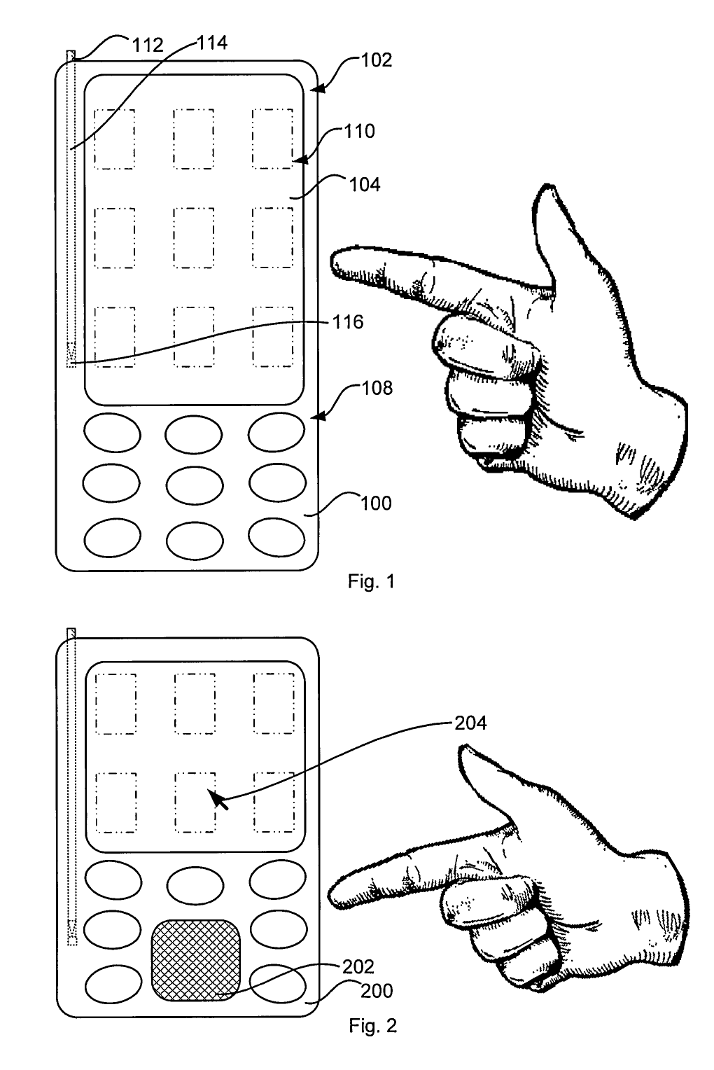

FIG. 1 illustrates an apparatus 100, e.g. a mobile phone, a digital camera, a media player or a personal digital assistant, having a user interface (UI) 102, which can comprise a screen 104, one or more keys 108, and/or other input or output means (not shown). A part of the UI comprises a software controlled UI, here called an UI environment. The UI environment is thus adaptable. The UI environment can comprise a graphical UI, which adapts to an application performed by the apparatus 100 by presentation of information graphically such that a user is enabled to interact with the apparatus 100. The interaction can be performed by navigating through UI items 110, e.g. by some navigation input such as a joystick, navigation key(s), or navigation wheel, or by a touch sensitive input, such a touch sensitive display which can be actuated by touching the areas of the display where the UI items to be selected or manipulated appear. This can be made by using a finger or by using a stylus 112. The stylus 112 can be stored in the apparatus 100 when not used. The stylus 112 is preferably stored in a dedicated storage unit 114 of the apparatus 100. The storage unit 114 can be a suitable cavity, slot or clip in or on the apparatus.

The degree of accuracy in operating the apparatus 100 normally differs depending on whether the apparatus 100 is operated by a finger or by the stylus 112, especially for users having big hands. One reason for this is the rather undefined contact between the finger and the touch sensitive display 104 compared to when using the stylus 112. Another reason is that the finger or hand covers a relatively large area of the display 104 for the user to see when pointing at a UI item 110. By using the stylus 112, the user is able to see more of the display 104 and to interact with it at a more defined point.

However, many users still want to be able to use a finger, at least for some applications, when interacting with the touch sensitive display 104. The UI environment can therefore be adapted to whether the user interacts by using a finger or by using the stylus 112. To determine a likely user behaviour at any instant, the apparatus 100 is provided by a sensor 116 which is arranged to sense whether the stylus 112 is stored in its storage unit 114. The sensor 116 can be a electromechanical switch, a magnetic, capacitive or optical sensor, or other suitable sensor providing an output signal which indicates whether the stylus 112 is stored in the storage unit 114 or not. Thus, is can be presumed that if the stylus 112 is not stored in the storage unit 114, the user intends to use the stylus 112 for interaction, and when the stylus 112 is stored in the storage unit 114, the user intends to use a finger for the interaction.

The UI environment is adapted based on the output of the sensor 116. For example, fewer and larger UI items 110 are used when the stylus 112 is determined to be stored in the storage unit 116, as illustrated in FIG. 1, while when the stylus 112 is determined to be out of the storage unit 116, more and thus smaller UI items 110 can be presented and interacted with, as illustrated in FIG. 3. The size of the UI items 110 can be changed. The distance between the UI items 110 can be changed. The number of presented UI items 110 can be changed. Speed settings for interaction with the UI items 110 can be changed, e.g. repeat rate for double-tap. Resolution of interaction detection can be changed. Touch sensitivity settings can be changed. Profile, such as in-door, out-door, in-car, etc. can be changed. Appearance on the display 104, such as theme, can be changed.

FIG. 2 illustrates an apparatus 200 with similar features and options as the one illustrated in FIGS. 1 and 3, but in the apparatus 200 of FIG. 2 interaction is performed by touching a touchpad 202 for controlling a cursor 204 on the screen. Similar to the apparatus 100 illustrated in FIGS. 1 and 3, the apparatus 200 adapts its UI environment to whether the stylus is in its storage unit or not, such as illustrated in FIG. 4, where the apparatus 200 is operated with the stylus out of its storage unit.

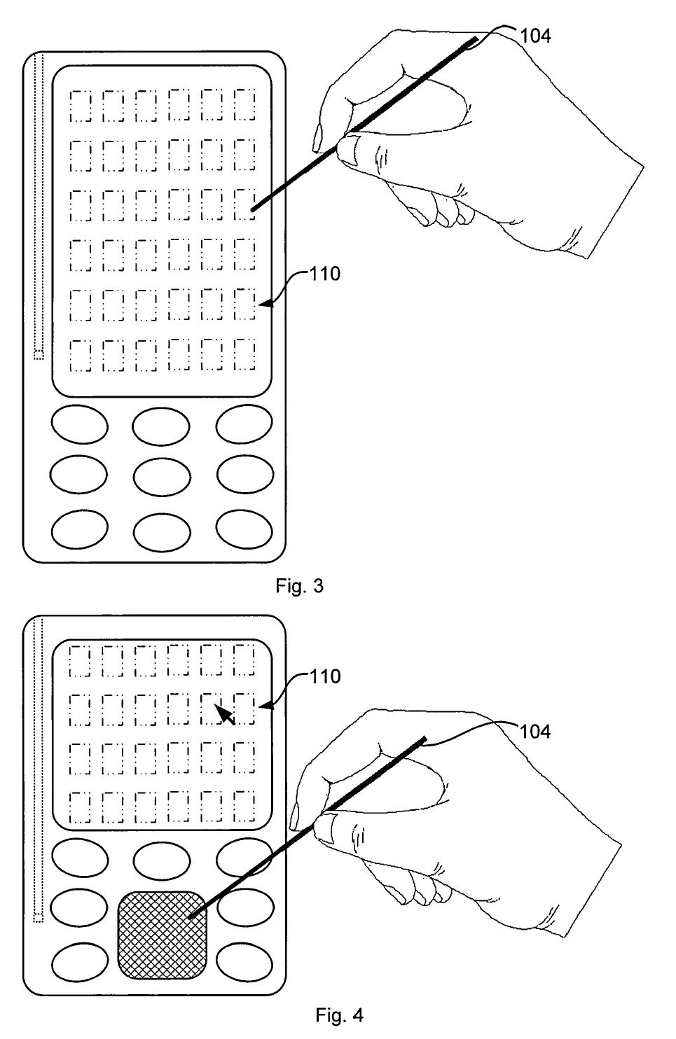

FIG. 5 is a flow chart illustrating a method for adapting the UI environment according to an embodiment. In a determination step 500, it is determined whether the stylus is stored in the storage unit. The determination 500 can be performed from a signal of a sensor, as elucidated above. In an adaptation step 502, the UI environment is adapted based on the determination. The adaptation of the UI environment has been elucidated above.

FIG. 6 is a flow chart illustrating a method for adapting the UI environment according to an embodiment. In a determination step 600, it is determined whether the stylus is stored in the storage unit. The determination 600 can be performed from a signal of a sensor, as elucidated above. In a decision step 602, it is decided from the determination 600 how to proceed the method. If the stylus is stored in the storage unit, the method proceeds to a first mode entering step 604, where a first mode is entered, and the method then proceeds to a first mode adaptation step 605, where the UI environment is adapted for finger actuation according to any of the examples that has been demonstrated above with reference to FIGS. 1 and 2. If the stylus is out of the storage unit, the method proceeds to a second mode entering step 606, where a second mode is entered, and the method then proceeds to a second mode adaptation step 607, where the UI environment is adapted for stylus actuation according to any of the examples that has been demonstrated above with reference to FIGS. 3 and 4.

The methods demonstrated with reference to any of FIGS. 5 and 6 can adapt graphical UI item(s) to whether the stylus is stored in the storage unit. Presenting of graphical UI items is preferably adapted such that they are suitable for actuation by using a stylus or a finger depending on whether the stylus is determined to be stored in the storage unit. This can be performed by executing a predefined set of software instructions in dependence of the determination. The set of software instructions to be executed can change the appearance of the UI environment. For example, fewer and larger UI items 110 can be used when the stylus is determined to be stored in the storage unit, while when the stylus is determined to be out of the storage unit, more and thus smaller UI items can be presented and interacted with. Further examples are that the size of the UI items can be changed, the distance between the UI items can be changed, the number of presented UI items can be changed, speed settings for interaction with the UI items can be changed, e.g. repeat rate for double-tap, resolution of interaction detection can be changed, touch sensitivity settings can be changed, profile, such as in-door, out-door, in-car, etc. can be changed, and/or appearance on the display, such as theme, can be changed.

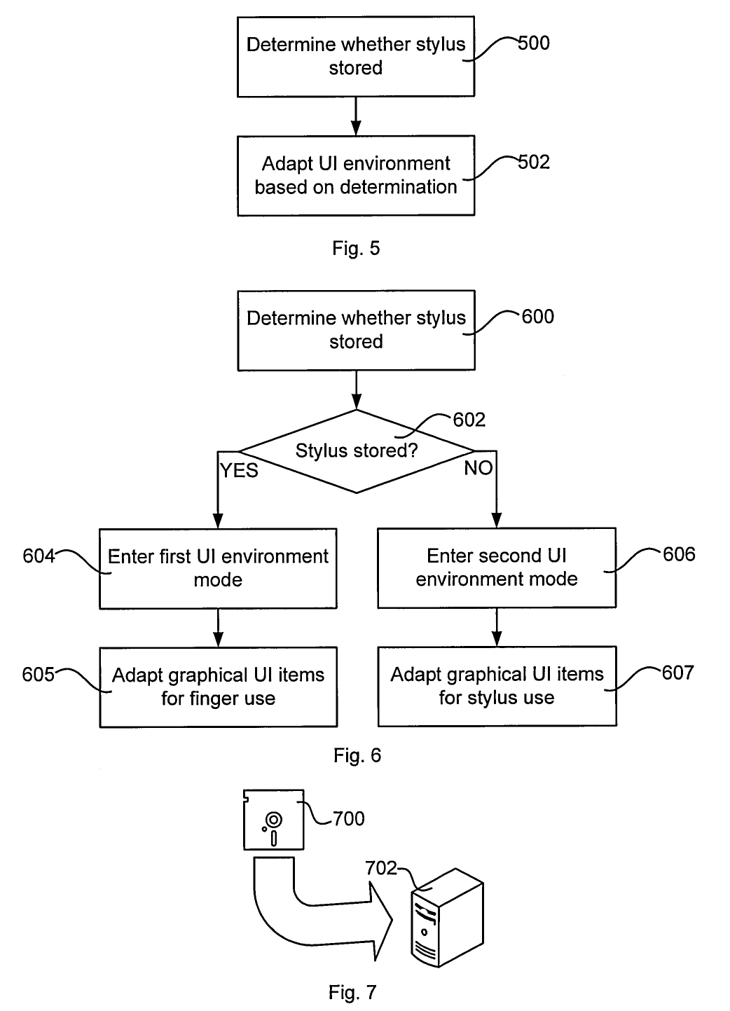

The methods according to the present invention are suitable for implementation with aid of processing means, such as computers and/or processors. Therefore, there is provided computer programs, comprising instructions arranged to cause the processing means, processor, or computer to perform the steps of any of the methods according to any of the embodiments described with reference to FIGS. 5 and 6, in any of the apparatuses described with reference to FIGS. 1 to 4. The computer programs preferably comprises program code which is stored on a computer readable medium 700, as illustrated in FIG. 7, which can be loaded and executed by a processing means, processor, or computer 702 to cause it to perform the methods, respectively, according to embodiments of the present invention, preferably as any of the embodiments described with reference to FIGS. 5 or 6. The computer 702, which can be present in any of the apparatuses as illustrated in FIGS. 1 to 4, and computer program product 700 can be arranged to execute the program code sequentially where actions of the any of the methods are performed stepwise, or be performed on a real-time basis, where actions are taken upon need and availability of needed input data. The processing means, processor, or computer 702 is preferably what normally is referred to as an embedded system. Thus, the depicted computer readable medium 700 and computer 702 in FIG. 7 should be construed to be for illustrative purposes only to provide understanding of the principle, and not to be construed as any direct illustration of the elements.

1. An electronic apparatus comprising a user interface environment for operating the electronic apparatus wherein the user interface environment is arranged to present at least one graphical user interface item for user interaction, the electronic apparatus further comprises
an actuation position detector devised to detect user actuation;
a stylus;
a storage unit configured to store the stylus; and
a sensor unit configured to produce an output indicative of whether the stylus is stored in the storage unit and operatively coupled to the user interface environment,
wherein the user interface environment is adapted based on the output from the sensor unit.

2. The electronic apparatus according to claim 1, wherein the graphical user item comprises at least one user selectable item, which upon selection is associated with execution of a command for operating the electronic apparatus.

3. The electronic apparatus according to claim 1, wherein the dimension of the at least one graphical user interface item is varied based on the output from the sensor unit.

4. The electronic apparatus according to claim 1, wherein the number of selectable graphical user interface items is varied based on the output from the sensor unit.

5. The electronic apparatus according to claim 1, wherein the user interface environment has at least two modes:
a first mode, wherein the user interface environment is adapted for actuating the actuation position detector using a finger;
a second mode, wherein the user interface environment is adapted for actuating the actuation position detector using the stylus,
wherein the user interface environment alternates between the two modes based on the output from the sensor unit.

6. The electronic apparatus according to claim 5, wherein the user interface environment is in the first mode when the output from the sensor unit indicates that the stylus is stored in the storage unit.

7. The electronic apparatus according to claim 6, wherein the graphical user item comprises at least one user selectable item, which upon selection is associated with execution of a command for operating the electronic apparatus, and wherein the at least one selectable graphical user interface item is larger in first mode compared to the second mode.

8. The electronic apparatus according to claim 1, wherein the graphical user interface items comprise any of a group comprising pictogram, grapheme, icon, virtual buttons, soft keys, menu selections, files, short-links, software program icons, letter icons and number icons.

9. The electronic apparatus according to claim 1, comprising:
a display unit configured to display the at least one graphical user interface item of the user interface environment;
a display control unit operationally coupled to the sensor unit, and configured to provide image data to the display unit;
wherein the image data provided by said display control unit comprises the at least one graphical user interface item and depends on the output from the sensor unit.

10. The electronic apparatus according to claim 1, further comprising a user actuation detection control unit configured to control a least one parameter of the actuation position detector, the at least one parameter comprising any of a group comprising sensitivity, repeat rate and resolution,
wherein the user actuation detection control unit adjusts the at least one parameter based on the output from the sensor unit.

11. The electronic apparatus according to claim 1, wherein the user actuation position detector comprises a touch sensitive unit, which identifies a user selection upon physical contact between a finger or the stylus with the touch sensitive unit.

12. A method for adapting a user interface environment of an electronic apparatus, the method comprising
determining whether a stylus is stored at a storage unit configured to store the stylus;
adapting the user interface environment based on whether the stylus is stored in the storage unit.

13. The method according to claim 12, wherein the adapting comprises adapting at least one graphical user interface item of the user interface environment to whether the stylus is stored in the storage unit.

14. The method according to claim 12, further comprising
alternating the user interface environment between a first mode, in which the user interface environment is adapted for operating the electronic apparatus using a finger, and a second mode, in which the user interface environment is adapted for operating the electronic apparatus using the stylus, depending on whether the stylus is stored in the storage unit; and
determining the mode of the user interface environment to be in the first mode when the stylus is stored in the storage unit.

16. The method according to claim 12, further comprising
presenting a selected set of graphical user interface items of the user interface environment such that the user interface items are available for actuation depending on whether the stylus is stored in the storage unit.

17. The method according to claim 12, further comprising
executing at least one predefined software program depending on whether the stylus is stored in the storage unit.

18. The method according to claim 12, further comprising
adapting a theme of the user interface environment depending on whether the stylus is stored in the storage unit.

19. A computer readable medium comprising program code, which when executed by a processor comprised in an electronic apparatus, causes the processor to
determine whether a stylus is stored in a storage unit based on data from a sensor unit;
adjust a user interface environment based on whether the stylus is stored in the storage unit.
